(19) United States
(12) Patent Application Publication
(10) Pub. No.: US 2004/0044490 A1
(43) Pub. Date: Mar. 4, 2004

(54) Method for testing the transmission of text messages by radio devices

(76) Inventor: Matthias Weber, Feldkirchen (DE)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/297,725

(22) PCT Filed: Jun. 8, 2001
(86) PCT No.: PCT/DE01/02171

(30) Foreign Application Priority Data
Jun. 8, 2000 (DE) 10028029.3

(51) Int. Cl. G01D 3/00

(52) U.S. Cl. 702/108; 702/122; 340/7.2; 455/423

(57) ABSTRACT

According to a method for testing the ability of text messages to be received and/or transmitted by radio devices (2), using a testing device (1), a text message is sent from the testing device (1) to the radio device (2). This is a simple method of testing the transmissibility of text messages using any sets of characters. Before step (a), the text message is loaded into a storage area (3) of the testing device (1) as a bit sequence. The invention also relates to a corresponding testing device (1) for carrying out this method.

The present invention relates to a method for testing the reception and/or transmission capability for text messages by radio devices using a test set as claimed in the precharacterizing clauses of patent claims 1 and 13. The present invention also relates to a method for displaying messages on a radio device as claimed in the precharacterizing clause of patent claim 14. Finally, the present invention relates to a test device for testing radio devices as claimed in the precharacterizing clause of patent claim 15.

Test sets for radio devices, in particular for mobile telephones, are known from the prior art. The test sets are used during the final inspection stage of mobile telephone manufacture or by a specialist dealer or repair workshop to check the mobile telephone for compliance with the specifications that are required for operation in a network. If the test result is negative, the fault should also be located. The transmission and/or reception path of the mobile telephone is normally tested during functional tests such as these. For an example of a written reference to this prior art, reference should be made to the publication “Meβtechnik für GSM-Funktelefone” [Measurement technology for GSM radio telephones] by R. Schoblick, in Funkschau 16/97, pages 64 to 66.

Furthermore, as is known, short messages (so-called SMS messages, Short Message Service) can be transmitted, for example, in the GSM network. In this case, short alphanumeric messages which have letters and numbers, can be displayed on the display device of a mobile telephone. In the GSM system, there are in this case two different types of short message transmission, namely, firstly, a point-to-point SMS, that is to say service which allows the transmission of a short message, for example from one mobile telephone to another mobile telephone, and secondly a transmission service between the network and all the users within a cell or service area, with the latter being known as cell transmission (cell broadcast SMS).

A seven-bit coding system is currently used as the alphabet in the GSM Standard, which allows the transmission of a text message with 2⁷, that is to say 128, characters. One new coding method is the “Universal Coding Scheme 2” (UCS2). This coding method provides for the use of 16-bit characters, so that a larger character set can be represented. This character set then also allows the transmission of, for example, Chinese, Cyrillic or other non-“Roman” characters.

The prior art thus, in particular, has the disadvantage that complex coding and decoding devices need to be implemented in the test sets for non-western character sets. In this case, it should be borne in mind in particular that further types of characters will need to be added continually over the course of time, so that there will be a need for continual updating.

The object of the present invention is thus to avoid the disadvantages of the prior art and, in particular, to develop a method and an apparatus of the type mentioned initially such that the capability to transmit short messages can be tested without a large amount of programming effort.

One particular advantage of the present invention is that the process of testing the transmission and reception capability for short messages on a mobile telephone can be carried out even by an operator who cannot understand the displayed short messages.

A further advantage of the present invention is that, at the moment, yet unavailable alphabets can easily be updated and tested, since all the conventional test sets can be operated using the method according to the invention.

Finally, it is advantageous that, according to the present invention, the test set need not have any coding/decoding functions, any display device or any input device for the character set to be tested. Implementation of the method according to the invention is therefore particularly suitable for currently available test stations.

The text message, which is stored as a bit sequence, is advantageously a message in a language which does not have Roman letters, for example Chinese, Cyrillic or Greek. The use of the invention is actually particularly advantageous for a language such as this since, according to the invention, the radio test station need not have an implementation provided for this purpose, for example input, coding/decoding or display devices. The user need not necessarily be familiar with this language for testing, either. In order to test all the possible characters in the corresponding character set, it is preferable for the message to have all the characters of this language.

A data item/an information item or an identifier which is characteristic of this language is advantageously loaded into the radio test station with the text message. This allows different identification data to be provided for the various text messages in different languages, allowing the various text messages to be organized and to be called up again later.

Further preferred embodiments of the invention are disclosed in the dependent patent claims.

The invention, as well as further features, aims, advantages and application options of it, will be explained in more detail in the following text using a description of preferred exemplary embodiments and with reference to the attached drawings. In this case, all the described features and/or all the illustrated features in their own right or in any desired sensible combination form the subject matter of the present invention, to be precise irrespective of the way in which they are combined in the patent claims or are referred back to. The same reference symbols denote the same or corresponding elements or functions throughout the drawings. In the drawings:

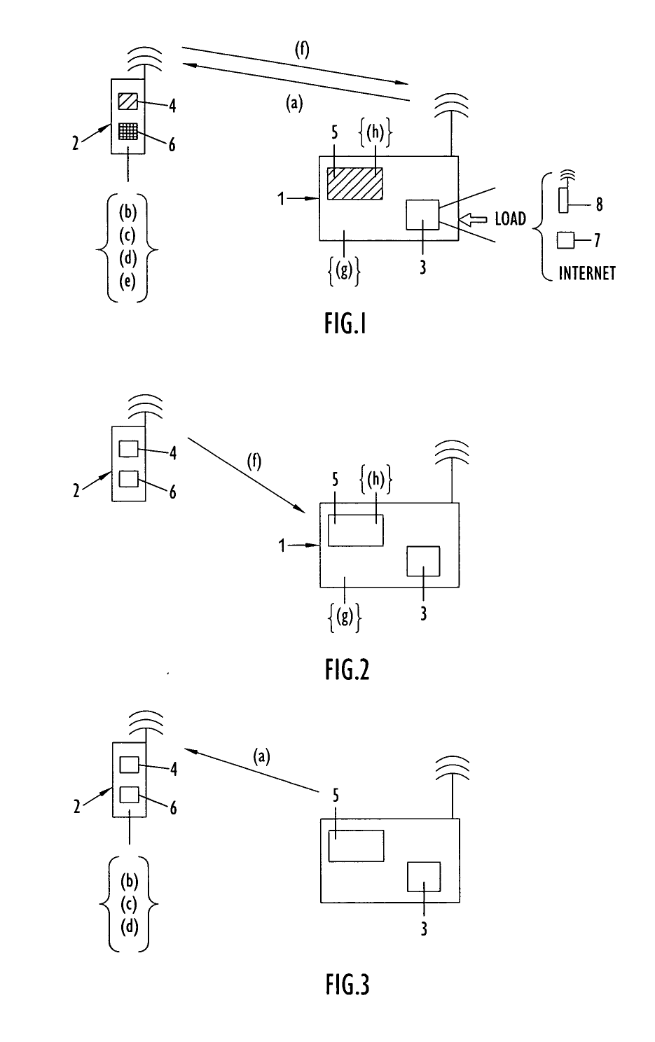

FIG. 1 shows a schematic illustration of a first exemplary embodiment of the present invention;

FIG. 2 shows a schematic illustration of a second exemplary embodiment (a pure transmission test) of the present invention; and

FIG. 3 shows a schematic illustration of a third exemplary embodiment (a pure reception test) of the present invention.

FIG. 1 shows, schematically, a radio test station 1 for testing mobile telephones 2. The schematic illustration in FIG. 1 shows that the radio test station 1 has a memory device in which a text message is stored in a memory field provided for this purpose. This text message can be stored in the radio test station 1 at the factory, and can be called up as required. Particularly when updating is being carried out, it is likewise preferable for the text message to be loaded into the memory area 3 before the actual short message transmission test is carried out. This may be done, for example, without the use of wires via a radio interface by means of a “golden” mobile telephone 8. In this context, the expression golden mobile telephone means a mobile telephone that is known to be suitable for transmitting text messages. As is illustrated schematically in the drawing, the text message may also be loaded via an interchangeable storage medium 7 such as a floppy disk, or else via a data network or a network such as the Internet, into the memory device 3. By way of example, the radio test station 1 sets up a test network via the air interface, and the mobile telephone 2 to be tested can register in this test network for test purposes. The radio link is illustrated schematically. However, a cable link may be provided instead of the radio apparatus. The mobile telephone 2 has a display device 4 on which, in particular, a transmitted text message can be displayed. The mobile telephone 2 to be tested is, in particular, of a type which can receive, decode and display text messages in non-Roman languages, for example in Chinese characters. The radio test station 1 also has a display device 5, on which, in particular, a test result can be displayed. In the simplest case, “test passed”/“test failed” is displayed for this purpose.

In order to assist understanding of the present invention, the method steps according to the invention are likewise shown in curly brackets in FIG. 1. In order to operate the radio test station according to the invention, a text message which is stored in the memory area 3 is transmitted from the radio test station 1 to the mobile telephone 2 in a step (a). The text message is in this case stored in the radio test station 1 as a bit sequence, since the radio test station is preferably not able to support the coding scheme which the handling of non-Roman characters allows. In a step (b), the text message is now received by the radio device 2 in the mobile telephone 2. In a step (c), the text message is decoded in the mobile telephone 2 and, in a step (d), is indicated on the display device 4 of the mobile telephone 2. A correct display of the text messages, which are transmitted from the radio test station 1 to the mobile telephone 2, on the display device 4 of the mobile telephone 2 thus indicates that text messages, in particular SMS messages, can be received correctly by the mobile telephone 2. However, for correct operation, it is likewise necessary to check the capability to transmit text messages. For this purpose, in the preferred exemplary embodiment, the received text message is coded once again in a step (e), and is transmitted back to the radio test station 1 in a step (f). In the radio test station 1, the text message which was transmitted in the step (a) and the text message which was received in the step (f) are compared with one another at the bit level and, if they match, an indication is produced that the test result is positive. It should be noted that the described method by displaying the text message on the display device 4 of the mobile telephone 2 makes it possible to determine whether there is a fault in the reception path or in the transmission path of the mobile telephone 2. It should also be noted that the SMS message which is used as the text message in the preferred exemplary embodiment in general has a header, which contains in particular control commands and control information to which the actual text message is attached. It should be obvious to those skilled in the art that only the actual text messages are in each case compared, and that the header lines or headers are changed or adapted as appropriate for the transmission paths. Thus, in the first exemplary embodiment and according to the invention, a text message is, so to speak, reflected back at the mobile telephone 2, with the header being modified, to the radio test station 1. In this case, the actual coding scheme need not be implemented in the radio test station 1 in order to assess whether the test result is positive or negative.

FIG. 2 now shows a second exemplary embodiment of the present invention, schematically. The illustration in FIG. 2 shows that, in this exemplary embodiment, only the capability of the mobile telephone 2 to transmit text messages is tested. For this purpose, in a step (f′), a short message which is entered for example on a keypad 6 of the mobile telephone 2 is transmitted to the test station 1. The short message which is entered in the mobile telephone 2 for testing is in this case the same as the message stored in advance in the memory device 3, so that the comparison result can be displayed on the display device 5, which indicates whether the mobile telephone 2 has the capability to transmit.

In the exemplary embodiment shown in FIG. 3, only the capability of the mobile telephone 2 to receive text messages is checked. For this purpose, the text message which is stored in advance in the memory device 2 of the radio test station 1 is transmitted to the mobile telephone 2 in a step (a). It is then possible to read from the display device 4 of the mobile telephone 2 whether the mobile telephone 2 has the required reception capability.

The invention has been explained in relatively great detail above with reference to a description of preferred exemplary embodiments. However, it is obvious to those skilled in the art that different changes and modifications can be made without departing from the idea on which the invention is based.

### List of Reference Symbols

1 Test set or radio test station

2 Radio device or mobile telephone

3 Memory device of the test set

4 Display device of the mobile telephone

5 Display device of the test set

6 Input device or keypad of the radio device

7 Interchangeable storage media

8 “Golden” mobile telephone

1. A method for testing the reception and/or transmission capability for text messages by radio devices (2) using a test set (1), which has the following step:
(a) transmission of a text message by the test set (1) to the radio device (2);
characterized in that the text message is loaded as a bit sequence into a memory area (3) of the test set (1) before the step (a).

2. The method as claimed in claim 1, characterized in that the radio device (2) is a mobile telephone.

3. The method as claimed in claim 1 or 2, characterized in that the text message is an SMS message.

4. The method as claimed in one of claims 1 to 3, characterized in that the method also has the following step:
(b) reception of the text message by the radio device (2);
(c) decoding of the text message by the radio device (2); and
(d) displaying of the decoded text message on a display device (4) of the radio device (2).

5. The method as claimed in one of the preceding claims, characterized in that the method also has the following steps:
(e) coding of the decoded text message;
(f) transmission of the coded text message back;
(g) comparison of the coded text message with the text message which was loaded as a bit sequence into the test set (1); and
(h) displaying of the comparison result.

6. The method as claimed in one of the preceding claims, characterized in that the text message is loaded as a bit sequence into a memory area (3) of the test set (1) via a radio interface of the test set (1).

7. The method as claimed in one of the preceding claims, characterized in that the text message is loaded as a bit sequence into a memory area (3) of the test set (1) via an interchangeable data storage medium (7).

8. The method as claimed in one of the preceding claims, characterized in that the text message is loaded as a bit sequence into a memory area (3) of the test set (1) via a computer network.

9. The method as claimed in claim 8, characterized in that the computer network is the Internet.

10. The method as claimed in one of the preceding claims, characterized in that the text message, which is stored as a bit sequence, is a message in a language which does not use Roman letters.

11. The method as claimed in claim 10, characterized in that the message has all the characters of this language.

12. The method as claimed in claim 10 or 11, characterized in that, a data item which is characteristic of this language is loaded in addition to the text message.

13. A method for testing the reception and/or transmission capability for text messages by radio devices (2) using a test set (1), which has the following step:
(f′) transmission of a text message from the radio device (2) to the test set (1);
characterized in that, before step (f′), the text message is loaded as a bit sequence into a memory area (3) of the test set (2).

14. A method for displaying text messages on a radio device (2), in particular a mobile telephone, characterized in that the text message is a handling instruction or a test result, and in that the text message is transmitted from the test set (1) to a mobile telephone, is decoded and is displayed.

15. A test device (1) for carrying out the method as claimed in one of the preceding claims, characterized in that the test device (1) has a memory device (3) in which a text message that is to be transmitted is loaded as a bit sequence.
